(19) United States
(12) Patent Application Publication
(10) Pub. No.: US 2024/0028093 A1
(43) Pub. Date: Jan. 25, 2024

(54) System and Method to Maximize Power Delivery for USB Power Delivery Programmable Power Supplies

(71) Applicant: Dell Products L.P., Round Rock, TX (US)

(72) Inventors: Geroncio Ong Tan, Austin, TX (US); Wei Cheng Yu, New Taipei City (TW); Chi-Che Wu, Taipei (TW); Tsung-Cheng Liao, Taoyuan City (TW)

(73) Assignee: Dell Products L.P., Round Rock, TX (US)

(21) Appl. No.: 17/870,883

(22) Filed: Jul. 22, 2022

(51) Int. Cl. G06F 1/26; G06F 1/28

(52) U.S. Cl. CPC G06F 1/266; G06F 1/28

(57) ABSTRACT

Described are system and methods for maximizing charging power to an information handling system (IHS) from a programmable power supply (PPS). The IHS and the PPS initiate communication with one another. Information is exchanged as to the capabilities of the PPS for providing charging power to battery cells of the IHS, and information as to the battery cells of the HIS. Charging power from the PPS based on the configuration and capability of the battery cells of the IHS, and charging power is kept at a maximum power throughout charging of the battery cells.

### BACKGROUND OF THE INVENTION

### Field of the Invention

The present invention relates to information handling systems. More specifically, embodiments of the invention provide for maximizing power delivery of programmable power supplies to information handling systems, such as notebook/laptop computers.

### Description of the Related Art

Information handling systems, such as notebook/laptop computers, include batteries/battery cells to provide operational power. Implementations provide for such batteries/battery cells to be charged by charging component (i.e., charger) included in the information handling system. A separate programmable power supply (PPS) can be connected to the information handling system. The PPS provides power to the charging component. The PPS connects to an alternating current (AC) source and converts AC to direct current (DC) that is sent to the information handling system/charging component. Ideally, power delivery power (PDP) sent from the PPS is consistently at a maximum value that the information handling system/charging component can receive; however, power delivered from the PPS can be current limited, with voltage varying as power is delivered. In other words, power that is delivered is not at a maximum capability. This leads to limited charging of the batteries or battery cells of the information handling system.

For example, a PPS may be designed to provide one PDP to set by an augmented power delivery object (APDO). Different APDOs cannot set separate PDPs to increase power rating usage, since an APDO's maximum output current is limited to a high range of the APDO. The low range of the APDO lowers maximum output power. All output current between the low range and the high range is limited by the high range of APDO. Therefore, the low range of the APDO is not fully efficient in providing more power to batteries/battery cells that can receive greater power. Therefore, such a design does not take advantage of delivering more power to such batteries/battery cells.

Various implementations provide for a USB Type C standard connection between a PPS and a notebook/laptop computer. The USB Type C standard power delivery APDO maximum current is defined as the PDP rating divided by a maximum output voltage, not a dynamic PPS output voltage. For example, maximum output current for a 60 W/20V PPS is limited to 3 A. Such a limitation reduces the capability of a PPS in the low voltage range, such as 9V, where output power is only 27 W (9V*3 A). For a 60 W source, it would take about an hour to reach 80% remaining state of charge (RSOC) for the batteries/battery cells. Because of APDO maximum current limitation (e.g., 3 A), a 60 W adapter limited to an average of 32.5 W (PPS range from 9.9V to 11.7V) requires 1.82 hrs to reach the same RSOC level. Therefore, the maximum APDO current as defined by USB Type C standard power delivery does not efficiently use the power delivery of the PPS throughout the entire programmable voltage range.

### SUMMARY OF THE INVENTION

Computer-implementable method for and information handling system for maximizing charging power to an information handling system (IHS) from a programmable power supply (PPS) comprising initiating communications between the IHS and PPS; receiving charging capability of the PPS; receiving a request for configuration and capability of battery cells of the IHS; sending the configuration and capability of the battery cells of the IHS; and receiving charging power from the PPS based on the configuration and capability of the battery cells of the IHS, wherein charging power is kept at a maximum power throughout charging of the battery cells. A programmable power supply (PPS) that provides maximum charging power to an information handling system (IHS) comprising a power delivery integrated circuit communicating to a power deliver controller of the IHS that provides charging capability of the PPS to HIS, sends a request for configuration and capability of battery cells of the HIS, receives the configuration and capability of battery cells; and a power conversion component that sends charging power from the PPS based on the configuration and capability of the battery cells of the IHS, wherein charging power is kept at a maximum power throughout charging of the battery cells.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 illustrates a system 200 for maximizing power delivery of programmable power supplies to information handling systems. as implemented in the present invention;

FIG. 3 is a generalized flowchart for power delivery of programmable power supplies to information handling systems as implemented in the present invention; and

FIG. 4 is a generalized flowchart for maximizing charging power to an information handling system as implemented in the present invention.

### DETAILED DESCRIPTION

Implementations include addressing programmable power supply (PPS) power level limitations. A PPS, also known as an AC adapter, is connected to an information handling system, such as a notebook/laptop computer. The connection can be through a USB Type C connection. Initially the PPS and information handling system can communicate using a common or standardized protocol such as DPO, or through specific vendor define messages. Certain implementations provide for the PPS to send messages to a power deliver integrated circuit (PD IC) of the information handling system in order to receive messages from batteries/battery cells of the information handling system. The messages from the batteries/battery cells can include a maximum power capacity of the batteries/battery cells which allows the PPS to set a maximum power delivery setting to protect the PPS from over power, while delivering maximum power to the information handling system.

In such implementations, a protocol or augmented power delivery object (APDO) is set up between the PPS and the information handling system, where vendor defined messages can be used. Upon an initial authentication, the information is exchanged between the PPS and information handling system. The information can include power capability of the PPS and configuration of the batteries/battery cells is exchanged. The PPS selects and provides a corresponding maximum power delivery to the information handling system, and assures that maximum power output is not exceeded. A scalable APDO profile is provided based on battery cell configuration, rather than the use of the USB Type C standardized PPS APDO. The capability of the APDO is extended to maximize PPS power capability throughout the entire programmable voltage range. Maximizing the output power allows a higher source current to the batteries/battery cells which results in a faster charge time.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer (e.g., notebook/laptop computer) a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

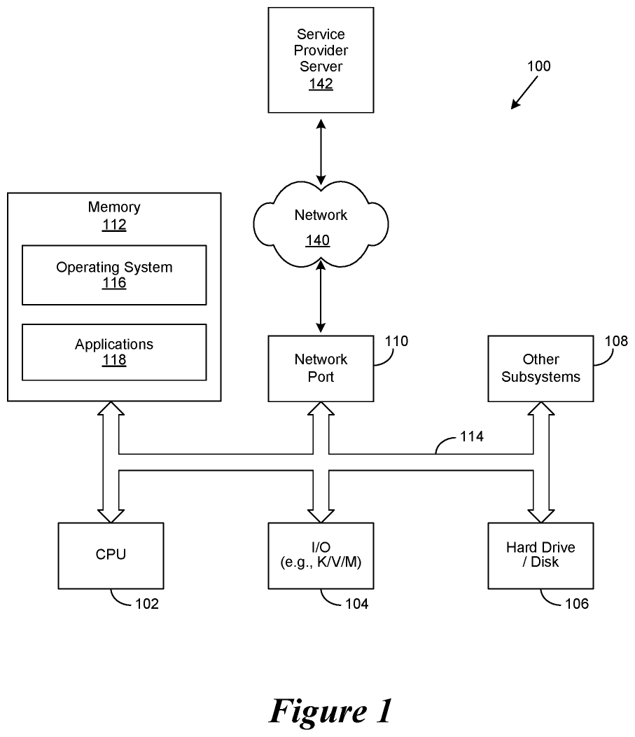

FIG. 1 is a generalized illustration of an information handling system 100. The information handling system 100 can be implemented as a computer, such as a desktop, server, tablet, notebook computer, laptop computer, etc. The information handling system 100 includes a processor(s) (e.g., central processor unit or “CPU”) 102, input/output (I/O) devices 104, such as a microphone, a keyboard, a video/display, a mouse, and associated controllers (e.g., K/V/M), a hard drive or disk storage 106, and various other subsystems 108 including batteries/battery cells. Various implementations provide for the I/O devices 104 to be external peripheral devices, such as keyboards, webcams, monitors, displays, etc. Implementations provide for such external devices are connected using cables based on standards such as universal serial bus (USB), including USB Type C. As further described herein, such connections can be to a programmable power supply (PPS).

In various embodiments, the information handling system 100 also includes network port 110 operable to connect to a network 140, where network 140 can include one or more wired and wireless networks, including the Internet. Network 140 is likewise accessible by a service provider server 142. The information handling system 100 likewise includes system memory 112, which is interconnected to the foregoing via one or more buses 114. System memory 112 can be implemented as hardware, firmware, software, or a combination of such. System memory 112 further includes an operating system (OS) 116. Embodiments provide for the system memory 112 to include applications 118.

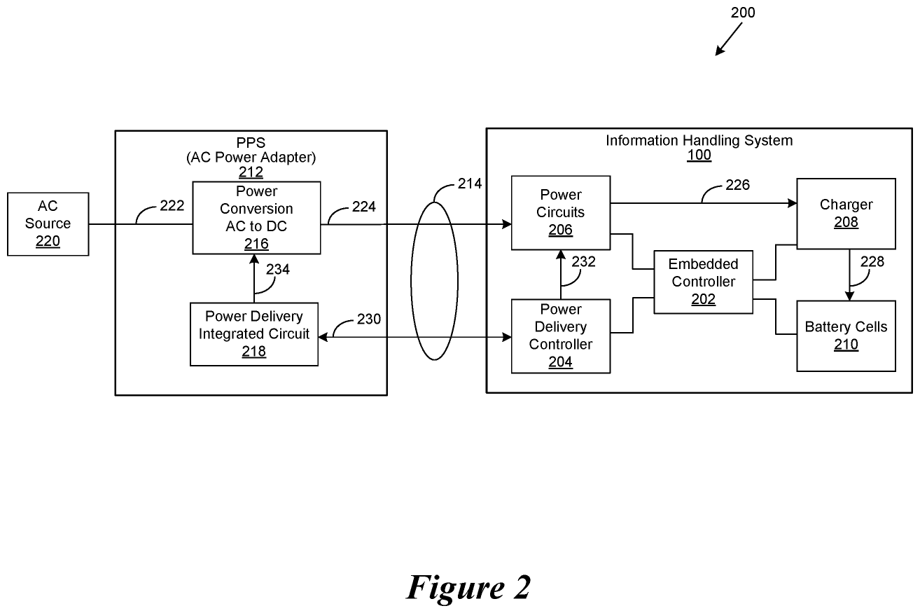

FIG. 2 shows a system 200 for maximizing power delivery of programmable power supplies to information handling systems. The system 200 includes an information handling system 100, such as a notebook/laptop computer as described in FIG. 1. In various implementations, the information handling system 100 includes an embedded controller 202, a power deliver controller 204, power circuits 206, a charging component or charger 208, and batteries or battery cells 210.

Implementations provide for the information handling system 100 to be connected to a programmable power supply (PPS) 212, also known as an AC power adapter. The PPS 212 can be implemented as a USB Type C power deliver (PD) PPS. Various implementations provide for connection 214 to be a USB Type C connection.

Implementations provide for the PPS 212 to include a power conversion component 216 to convert AC current to DC current. PPS 212 can also include a power delivery integrated circuit or PD IC 218.

The PPS 212 is connected to an AC source 220, such as an AC socket. The AC source 220 provides AC current 222 to the power conversion component 216. The power conversion component 216 converts the AC current 222 to DC current. DC current and voltage values 224 are provided to power circuits 206 of the information handling system 100. The power circuits 206 provide current and voltage values 226 to the charging component or charger 208. The charging component or charger 208 charges 228 the batteries or battery cells 210.

In various implementations, the embedded controller 202 communicates with and receives information from power deliver controller 204, power circuits 206, charging component or charger 208, and batteries or battery cells 210. For example, embedded controller 202 receives configuration and capacity information of batteries or battery cells 210, which is passed on to power deliver controller 204.

As further described herein, implementations provide for the power deliver controller 204 to communicate (receive and send) messages 230 to the PD IC 218. The power deliver controller 204 provides instructions/messages 232 to the power circuits 206. The PD IC 218 provides instructions/messages 234 to the power conversion component 216.

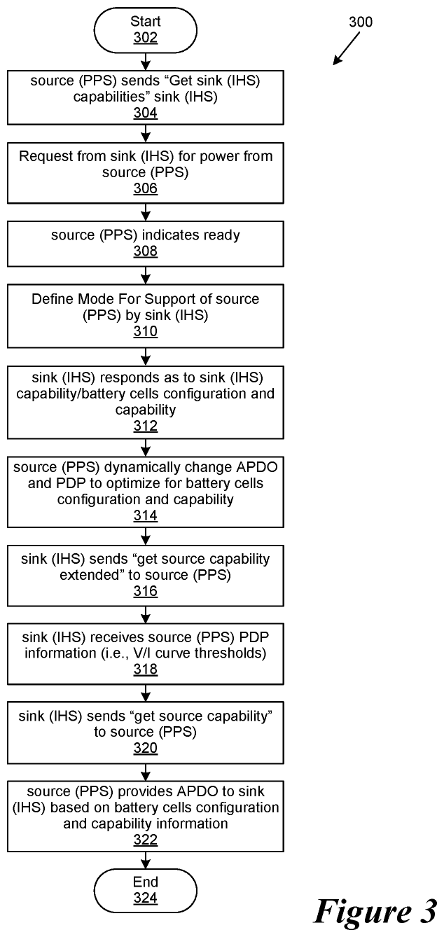

FIG. 3 is a generalized flowchart for power delivery of programmable power supplies to information handling systems. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

In various implementations, the system 200 as described above performs the steps of process 300. In particular, PPS 212 through the PD IC 218 to information handling system (IHS) 100 (e.g., a notebook/laptop computer). Implementations provide for the power deliver controller 204 of the information handling system 100 to communicate with the PD IC 218. The PPS 212 can be considered as a “source” since current/voltage/power is provided from the PPS 212. The information handling system 100 can be considered as a “sink” since power is consumed by the information handling system 100 (i.e., battery cells 210). The PPS 212 includes standard power delivery object (PDO) power profiles. Example PDO profiles include 5V/3 A, 9V/3 A, 15V/3 A, 20V/2.25 A.

At step 302, the process 300 starts. At step 304, the source or PPS 212 sends “get sink (IHS) capabilities” to the sink or information handling system (IHS) 100. The request message particularly is directed to capability and configuration of battery cells 210.

At step 306, a request is sent from the information handling system (IHS) 100 to the PPS 212 to provide power. At step 308, an indication is provided by the PPS 212 that the PPS 212 is ready to provide power to the information handling system (IHS) 100.

At step 310, the mode for support of the source or PPS 212 by the sink or information handling system (IHS) 100 is determined. This step can be performed using vendor defined messages. The mode for support can be discovered by the sink or information handling system (IHS) 100 from the source or PPS 212 and is chosen and entered by the sink or information handling system (IHS) 100. A acknowledge message can be sent from the source or PPS 212. The use of vendor defined messages can cease after mode is determined.

At the source or PPS 212, there can be power delivery power (PDP) information and augmented power deliver objects (APDO). Examples of PDP information include 36 w (2S), 40 W (3S), 40 W (4S). Examples of APDO include 6 v to 9V/4 A (2S), 9V to 13.3V/4 A (3S), 12V to 21V/3 A (4S). At the sink or information handling system (IHS) 100, a fixed PDO or an APDO can be selected. An example of an APDO is Min voltage=9V, Max voltage=13.3V, Max current=5 A or Max current=2 A.

At step 312, sink or information handling system (IHS) 100 responds as to the configuration and capability of battery cells 210.

The source or PPS 212 can have particular capabilities or power profiles, as to PDO or APDO. Examples of PDO include 5V/3 A, 9V/3 A, 15 v/3 A, 20V/2.25 A. An APDO example can include 9V to 13.3V/4 A (3S), 9V to 13.3V/2 A (3S). Power of the source or PPS 212 can be limited. For example, a power limit can be maximum power to 40 W, or maximum power to 53.2 W.

At step 314, the source or PPS 212 dynamically changes the APDO and PDP for optimum support of the battery cells 210 based on configuration and capability of battery cells 210.

At step 316, the sink or information handling system (IHS) 100 sends a “get source (IHS) capability extended” to the source or PPS 212. The capability is based on the particular capabilities or power profiles of PPS 212.

At step 318, sink or information handling system (IHS) 100 receives PPS 212 PDP information which can be in the form of voltage/current (V/I) threshold curves. At step 320, the sink or information handling system (IHS) 100 sends a “get source (IHS) capability” to the source or PPS 212

At step 322, the source or PPS 212 provides an APDO to the sink or information handling system (IHS) 100 based on configuration and capability of the battery cells 210. At step 324, the process 300 ends.

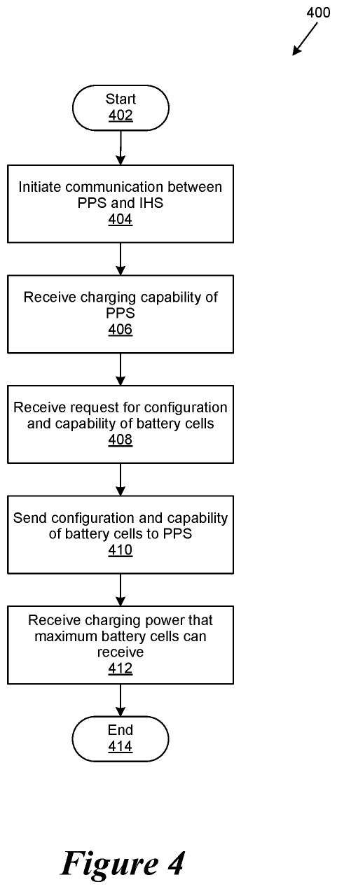

FIG. 4 is a generalized flowchart for maximizing charging power to an information handling system from a programmable power supply. The order in which the method is described is not intended to be construed as a limitation, and any number of the described method blocks may be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At step 402, the process 400 starts. At step 404, communication is initiated between the information handling system (IHS) 100 and the programmable power supply PPS 212. Implementations provide for the power deliver controller 204 of the IHS 100 to communicate with the PD IC 218 of the PPS 212.

At step 406, charging capability of the PPS 212 is received. Charging capability includes extended charging capability throughout the entire programmable voltage range of the PPS 212.

At step 408, a request is received as to the configuration and capability of the battery cells 210 of IHS 100. Capability of the battery cells 210 includes maximum power that the battery cells 210 can receive. At step 410, the configuration and capability of the battery cells 210 is sent to the PPS 212.

At step 412, charging power is received based on the configuration and capability of the battery cells 210. The charging power is kept at a maximum power throughout the charging. At step 414, the process 400 ends.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram step or steps.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

1. A computer-implementable method maximizing charging power to an information handling system (IHS) from a programmable power supply (PPS) comprising:
initiating communications between the IHS and PPS;
receiving charging capability of the PPS;
receiving a request for configuration and capability of battery cells of the IHS;
sending the configuration and capability of the battery cells of the IHS; and
receiving charging power from the PPS based on the configuration and capability of the battery cells of the IHS, wherein charging power is kept at a maximum power throughout charging of the battery cells.

2. The computer-implementable method of claim 1, wherein the IHS and the PPS are connected by a USB Type C connection.

3. The computer-implementable method of claim 1, wherein the charging capability of the PPS includes an extended charging capability throughout an entire programmable voltage range of the PPS.

4. The computer-implementable method of claim 1, wherein the charging capability of the PPS are defined by power delivery objects (PDO) or augmented power delivery objects (APDO).

5. The computer-implementable method of claim 4, wherein an APDO and power delivery power (PDP) are dynamically changed based on the configuration and capability of the battery cells of the IHS.

6. The computer-implementable method of claim 1 further comprising providing a mode for support as to the PPS.

7. The computer-implementable method of claim 1 further comprising receiving power deliver power (PDP) information that includes a voltage/current (V/I) thresholds.

8. An information handling system (IHS) comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for maximizing charging power received by the IHS from a programmable power supply (PPS) comprising instructions executable by the processor and configured for:
initiating communications between the IHS and PPS;
receiving charging capability of the PPS;
receiving a request for configuration and capability of battery cells of the IHS;
sending the configuration and capability of the battery cells of the IHS; and
receiving charging power from the PPS based on the configuration and capability of the battery cells of the IHS, wherein charging power is kept at a maximum power throughout charging of the battery cells.

9. The information handling system (IHS) of claim 8, wherein a power deliver controller of the IHS communicates with a power delivery integrated circuit of the PPS.

10. The information handling system (IHS) of claim 8, wherein the IHS and the PPS are connected by a USB Type C connection.

11. The information handling system (IHS) of claim 8, wherein the charging capability of the PPS includes an extended charging capability throughout an entire programmable voltage range of the PPS.

12. The information handling system (IHS) of claim 8, wherein the charging capability of the PPS are defined by power delivery objects (PDO) or augmented power delivery objects (APDO).

13. The information handling system (IHS) of claim 8 further comprising providing a mode for support as to the PPS.

14. The information handling system (IHS) of claim 8 further comprising receiving power deliver power (PDP) information that includes a voltage/current (V/I) thresholds.

15. A programmable power supply (PPS) that provides maximum charging power to an information handling system (IHS) comprising:
a power delivery integrated circuit communicating to a power deliver controller of the IHS that provides charging capability of the PPS to IHS, sends a request for configuration and capability of battery cells of the IHS, receives the configuration and capability of battery cells; and
a power conversion component that sends charging power from the PPS based on the configuration and capability of the battery cells of the IHS, wherein charging power is kept at a maximum power throughout charging of the battery cells.

16. The programmable power supply (PPS) of claim 15, wherein the IHS and PPS are connected by a USB Type C connection.

17. The programmable power supply (PPS) of claim 15, wherein the charging capability of the PPS includes an extended charging capability throughout an entire programmable voltage range of the PPS.

18. The programmable power supply (PPS) of claim 15, wherein the charging capability of the PPS are defined by power delivery objects (PDO) or augmented power delivery objects (APDO).

19. The programmable power supply (PPS) of claim 15 further comprising providing a mode for support as to the PPS.

20. The programmable power supply (PPS) of claim 15 further comprising receiving power deliver power (PDP) information that includes a voltage/current (V/I) thresholds.
